(19) United States
(12) Patent Application Publication
(10) Pub. No.: US 2023/0042482 A1
(43) Pub. Date: Feb. 9, 2023

(54) SERVER, METHOD, AND NON-TRANSITORY COMPUTER READABLE MEDIUM

(71) Applicant: TOYOTA JIDOSHA KABUSHIKI KAISHA, TOYOTA-SHI (JP)

(72) Inventors: Toyokazu NAKASHIMA, Nagoya-shi (JP); Takeshi TAKEMOTO, Nagoya-shi (JP); Naoko YAMAFUJI, Nagoya-shi (JP); Naoya OKA, Nagakute-shi (JP)

(73) Assignee: TOYOTA JIDOSHA KABUSHIKI KAISHA, TOYOTA-SHI (JP)

(21) Appl. No.: 17/812,838

(22) Filed: Jul. 15, 2022

(30) Foreign Application Priority Data
Aug. 3, 2021 (JP) 2021-127806

(51) Int. Cl. G06F 21/62; G07C 5/00

(52) U.S. Cl. CPC G06F 21/6218; G07C 5/008

(57) ABSTRACT

A server includes a controller that repeatedly acquires history data for a vehicle, and limits data items acquired as the history data in a case in which an age of the vehicle is greater than or equal to a first threshold.

### CROSS-REFERENCE TO RELATED APPLICATION

This application claims priority to Japanese Patent Application No. 2021-127806, filed on Aug. 3, 2021, the entire contents of which are incorporated herein by reference.

### TECHNICAL FIELD

The present disclosure relates to a server, a method, and a program.

### BACKGROUND

Technology for storing history data for a vehicle is known. For example, Patent Document 1 discloses technology for storing history data for a vehicle with an in-vehicle ECU.

### CITATION LIST

### Patent Literature

PTL 1: JP 2020-71594 A

### SUMMARY

Technology for storing history data for a vehicle has room for improvement.

It would be helpful to improve technology for storing history data for a vehicle.

A server according to an embodiment of the present disclosure includes a controller configured to:

repeatedly acquire history data for a vehicle; and

limit data items acquired as the history data in a case in which an age of the vehicle is greater than or equal to a first threshold.

A method according to an embodiment of the present disclosure is a method to be performed by a server, the method including:

repeatedly acquiring history data for a vehicle; and

limiting data items acquired as the history data in a case in which an age of the vehicle is greater than or equal to a first threshold.

A program according to an embodiment of the present disclosure is configured to cause a computer to:

repeatedly acquire history data for a vehicle; and

limit data items acquired as the history data in a case in which an age of the vehicle is greater than or equal to a first threshold.

According to an embodiment of the present disclosure, technology for storing history data for a vehicle is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of a server;

FIG. 4 is a block diagram illustrating a schematic configuration of a terminal apparatus;

FIG. 5 is a diagram illustrating an example of information about a vehicle;

FIG. 6 is a flowchart illustrating first operations of the server;

and

FIG. 7 is a flowchart illustrating second operations of the server.

### DETAILED DESCRIPTION

Hereinafter, an embodiment of the present disclosure will be described.

### Outline of Embodiment

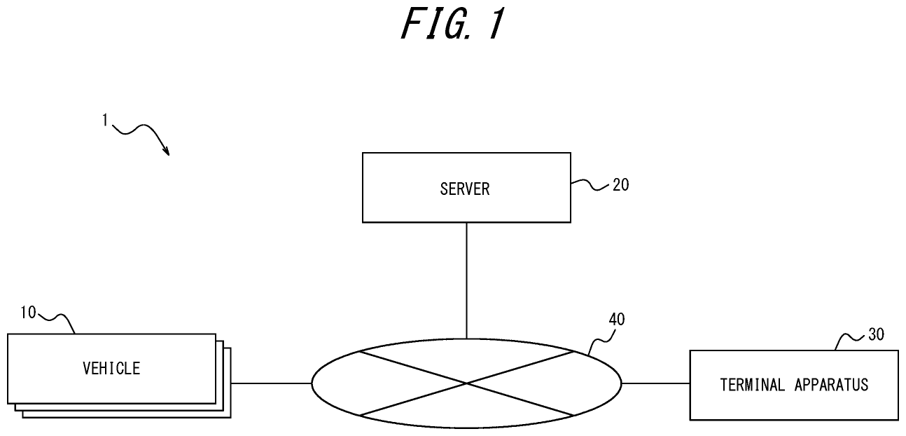

An outline of a system 1 according to an embodiment of the present disclosure will be described with reference to FIG. 1. FIG. 1 is a block diagram illustrating a schematic configuration of the system 1. The system 1 includes vehicles 10, a server 20, and a terminal apparatus 30.

Each vehicle 10 is an automobile, for example, but is not limited to this, and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

The server 20 is one computer or a plurality of computers in communication with each other. The terminal apparatus 30 is a computer such as a personal computer, a smartphone, or a tablet terminal.

For the sake of simplicity, FIG. 1 illustrates a plurality of vehicles 10 and one each of the server 20 and the terminal apparatus 30. However, the system 1 may include any number of vehicles 10, servers 20, and terminal apparatuses 30. The vehicles 10, the server 20, and the terminal apparatus 30 are communicably connected to a network 40 including, for example, the Internet, a mobile communication network, or the like.

First, an outline of the present embodiment will be described, and details thereof will be described later. The server 20 repeatedly acquires history data for the vehicle 10. The repeatedly acquired history data is stored in the server 20 as time-series data. The history data for the vehicle 10 is, for example, data measured using sensors installed in the vehicle 10. The history data for the vehicle 10 is, for example, used to evaluate the value of the vehicle 10 (e.g., the appraisal value of the vehicle 10) when the vehicle 10 is to be traded as a used vehicle. In this way, the history data for the vehicle 10 can be used to evaluate the value of the vehicle from multiple perspectives, and the value of the vehicle 10 can be evaluated with greater accuracy.

On the other hand, as the age of the vehicle 10 increases, the value of the vehicle 10 becomes more dependent on specific information such as the age of the vehicle 10 or the total distance traveled by the vehicle 10, and the use of history data for the vehicle 10 has less impact on the result of evaluating the value of the vehicle 10. Therefore, in a case in which the age of the vehicle 10 is greater than or equal to a first threshold, the server 20 limits the data items that are acquired as history data.

In this way, according to the present embodiment, the data items of the history data repeatedly acquired from the vehicle 10 are limited in a case in which the age of vehicle 10 is greater than or equal to the first threshold. Data items that have become less valuable to store as history data can thus be removed from among the targets for acquisition. Therefore, the technology for storing the history data for the vehicle 10 is improved in that an increase in the amount of the history data for the vehicle 10 stored in the server 20 or the like can be controlled in accordance with the age of the vehicle 10.

In the present disclosure, the age of the vehicle 10 is the period of time that has elapsed since the vehicle 10 was first registered as a new vehicle at a government agency such as a Transportation Branch Office. However, the age of the vehicle 10 may be the period of time that has elapsed since the vehicle 10 was manufactured or since the vehicle 10 was first sold.

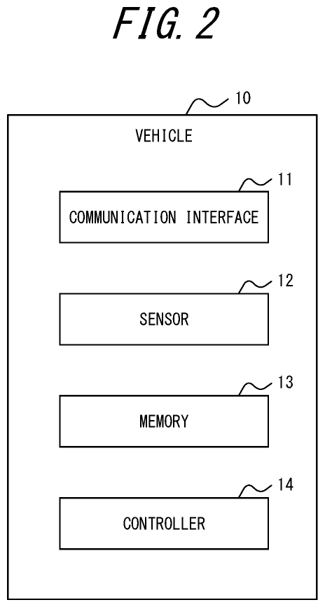

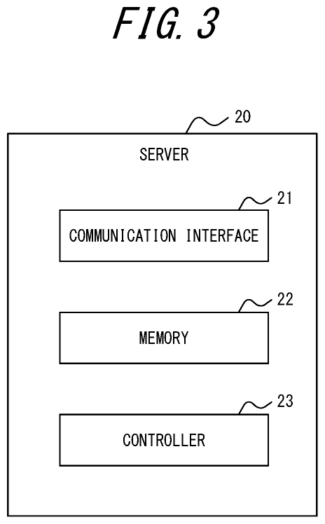

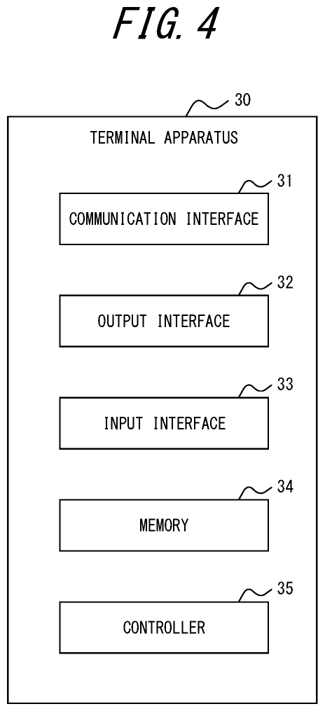

Next, with reference to FIG. 2, FIG. 3, and FIG. 4, configurations of the system 1 will be explained in detail. FIG. 2 is a block diagram illustrating a schematic configuration of the vehicle 10. FIG. 3 is a block diagram illustrating a schematic configuration of the server 20. FIG. 4 is a block diagram illustrating a schematic configuration of the terminal apparatus 30.

(Vehicle Configuration)

As illustrated in FIG. 2, the vehicle 10 includes a communication interface 11, a sensor 12, a memory 13, and a controller 14.

The communication interface 11 includes at least one communication interface for connecting to the network 40. The communication interface included in the communication interface 11 is compliant with mobile communication standards, such as the 4th generation (4G) standard or the 5th generation (5G) standard, for example, but is not limited to these, and may be compliant with any communication standard. In the present embodiment, the vehicle 10 communicates with the server 20 via the communication interface 11 and the network 40. The vehicle 10 may communicate via the communication interface 11 and the network 40 with computers other than the server 20 according to the present embodiment.

The sensor 12 includes one or more sensors. The sensors are used to measure the data included in the history data for the vehicle 10. The sensor can, for example, be a speed sensor, accelerometer, gyroscope, image sensor, infrared sensor, or the like. The sensor may be a receiver corresponding to a satellite positioning system such as the Global Positioning System (GPS). The sensor 12 senses phenomena such as speed, acceleration, angular velocity, the existence of impact to the vehicle 10, or the existence of failure.

For example, an odometer may be included in the sensor 12. The odometer senses the change in distance traveled by the vehicle 10 and outputs the result as the total distance traveled by the vehicle 10. Alternatively, an in-vehicle failure diagnostic device (on-board diagnostics device, or OBD device) may be included in the sensor 12.

The OBD device senses the occurrence of an abnormality in the in-vehicle equipment mounted in the vehicle 10 and outputs the result as failure history of the vehicle 10. An impact sensor may be included in the sensor 12. The impact sensor senses an impact to the vehicle 10 and outputs the result as a history of impact received by the vehicle 10.

The memory 13 includes one or more memories. The memories are semiconductor memories, magnetic memories, optical memories, or the like, for example, but are not limited to these. The memories included in the memory 13 may each function as, for example, a main memory, an auxiliary memory, or a cache memory. The memory 13 stores any information used for operations of the vehicle 10. For example, the memory 13 may store a system program, an application program, embedded software, and the like. The information stored in the memory 13 may be updated with, for example, information acquired from the network 40 via the communication interface 11.

The controller 14 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is, for example, an application specific integrated circuit (ASIC), but is not limited to this. The controller 14 controls the operations of the entire vehicle 10.

The controller 14 of the vehicle 10 generates the history data for the vehicle 10 and transmits the generated history data.

The history data for the vehicle 10 includes, for example, data on the distance traveled, data on the usage status, data on the failure status, or data on the maintenance status.

The data on the distance traveled includes time-series data such as the distance traveled by the vehicle 10, the speed, the acceleration, or the travel time. However, the data on the travel distance is not limited to these examples and may include any data used to evaluate the distance traveled by the vehicle 10.

The data on the usage status includes the engine on/off status of the vehicle 10, the operation history of the accelerator, the operation history of the brake, the operation history of the steering wheel, and the like. Data on the usage status may include time-series data on the fuel level or the battery level. However, the data on the usage status is not limited to these examples and may include any data used to evaluate the usage status of the vehicle 10.

The data on the failure status includes the history of impacts received by the vehicle 10, the failure history generated by the OBD device, the failure/error history of in-vehicle equipment, and the like. However, the data on the failure status is not limited to these examples and may include any data used to evaluate the failure status of the vehicle 10.

The data on the maintenance status includes the installation history, the replacement history, or the like of the in-vehicle equipment in the vehicle 10. However, the data on the maintenance status is not limited to these examples and may include any data used to evaluate the maintenance status of the vehicle 10.

The history data for the vehicle 10 may include data measured using sensors installed in the vehicle 10. Specifically, the controller 14 of the vehicle 10 uses one or more sensors included in the sensor 12 to measure one or more pieces of data included in the history data for the vehicle 10 described above. The controller 14 may include the one or more pieces of measured data and the corresponding measurement time in the history data for the vehicle 10. At the time the value of the vehicle 10 as a used vehicle is evaluated during a transaction, the history data for the vehicle 10 can thereby be referred to in order to obtain information that cannot be determined by simply looking at the vehicle 10. This can improve the accuracy of the evaluation of the value of the vehicle 10. However, the history data for the vehicle 10 may include data other than the data measured using the sensors installed in the vehicle 10, such as items and results of maintenance or inspection at a maintenance shop, for example. These pieces of data may be written to the memory 13 of the vehicle 10 at the time of maintenance or inspection at a maintenance shop. The controller 14 may include one or more pieces of the data stored in the memory 13 in the history data for the vehicle 10.

(Server Configuration)

As illustrated in FIG. 3, the server 20 includes a communication interface 21, a memory 22, and a controller 23.

The communication interface 21 includes at least one communication interface for connecting to the network 40. The communication interface included in the communication interface 21 is compliant with, for example, mobile communication standards, wired local area network (LAN) standards, or wireless LAN standards, but is not limited to these, and may be compliant with any communication standards. In the present embodiment, the server 20 communicates with the vehicle 10 and the terminal apparatus 30 via the communication interface 21 and the network 40. The server 20 may communicate via the communication interface 21 and the network 40 with computers other than vehicle 10 and the terminal apparatus 30 according to the present embodiment.

The memory 22 includes one or more memories. The memories included in the memory 22 may each function as, for example, a main memory, an auxiliary memory, or a cache memory. The memory 22 stores any information used for operations of the server 20. For example, the memory 22 may store a system program, an application program, a database, map information, and the like. The information stored in the memory 22 may be updated with, for example, information acquired from the network 40 via the communication interface 21.

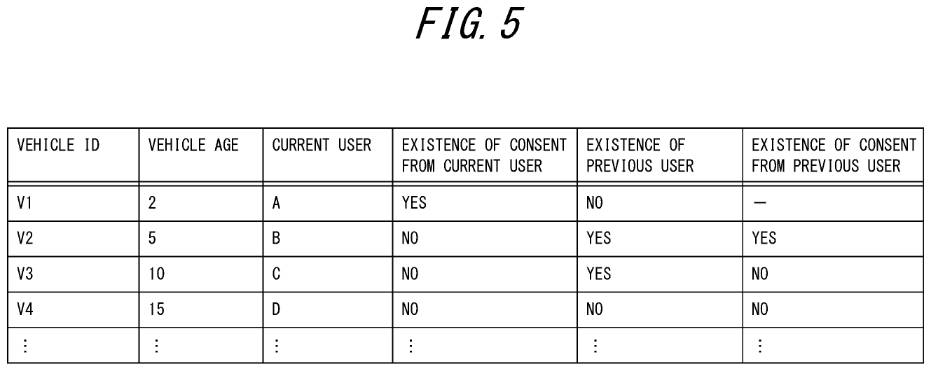

For example, the memory 22 may store information on the vehicle 10, as illustrated in FIG. 5. FIG. 5 illustrates an example of information on the vehicle 10. Information on the vehicle 10 includes, for example, a vehicle ID (identifier) of the vehicle 10, the vehicle age, the current user, the existence of consent from the current user, the existence of a previous user, and the existence of consent from the previous user.

The vehicle ID is information that can uniquely identify the vehicle 10. The vehicle ID is, for example, information that is dispensed by the server 20 but can also be unique information that is pre-assigned to the vehicle 10. Hereinafter, vehicles 10 with vehicle IDs V1 to V4 are also referred to as vehicles V1 to V4, respectively.

The vehicle age is the period of time that has elapsed since the vehicle 10 was first registered as a new vehicle, as described above. However, the age of the vehicle 10 may be the period of time that has elapsed since the vehicle 10 was manufactured or since the vehicle 10 was first sold.

The current user is information that indicates the current user of the vehicle 10, such as the name of the person who currently owns the vehicle 10.

The existence of consent from the current user is information indicating whether consent to disclose the history data to a third party has been obtained from the current user. Disclosing the history data to a third party may include making the history data viewable by a third party and providing the history data to a third party. Disclosing the history data to a third party may include disclosing the history data as is to a third party, as well as editing or excerpting the history data. The existence of consent is registered as affirmative in a case in which consent has been obtained from the current user at the dealership or the like that sold the vehicle 10 to the current user.

The existence of a previous user is information that indicates whether there was a user who owned the vehicle 10 before the current user. The existence of a previous user is registered affirmatively in a case in which, for example, the current user has purchased the vehicle 10 as a used vehicle or acquired the vehicle 10 from another person.

The existence of consent from the previous user is information indicating whether consent to disclose the history data, acquired during use of the vehicle 10 by the previous user, has been obtained from the previous user. The existence of consent is registered as affirmative in a case in which consent has been obtained from the previous user before the vehicle 10 is transferred from the previous user to the current user.

The controller 23 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 23 controls the operations of the entire server 20.

(Terminal Apparatus Configuration)

As illustrated in FIG. 4, the terminal apparatus 30 includes a communication interface 31, an output interface 32, an input interface 33, a memory 34, and a controller 35.

The communication interface 31 includes at least one communication interface for connecting to the network 40. The communication interface included in the communication interface 31 is compliant with mobile communication standards, such as 4G or 5G, but is not limited to these standards and may be compliant with any communication standard. In the present embodiment, the terminal apparatus 30 communicates with the server 20 via the communication interface 31 and the network 40. The terminal apparatus 30 may communicate via the communication interface 31 and the network 40 with computers other than the server 20 according to the present embodiment.

The output interface 32 includes at least one output apparatus. The output apparatus included in the output interface 32 is, for example, a display, a speaker, or the like. The output interface 32 outputs information in the form of images, sound, or the like.

The input interface 33 includes at least one input apparatus. The input apparatus included in the input interface 33 may be, for example, a touch panel, a camera, a microphone, an IC card reader, or the like. The input interface 33 accepts input operations by a user.

The memory 34 includes one or more memories. The memories included in the memory 34 may each function as, for example, a main memory, an auxiliary memory, or a cache memory. The memory 34 stores any information to be used for the operations of the terminal apparatus 30. For example, the memory 34 may store a system program, an application program, embedded software, or the like. The information stored in the memory 34 may be updated with, for example, information acquired from the network 40 via the communication interface 31.

The controller 35 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 35 controls the operations of the entire terminal apparatus 30.

(Server Operation Flow)

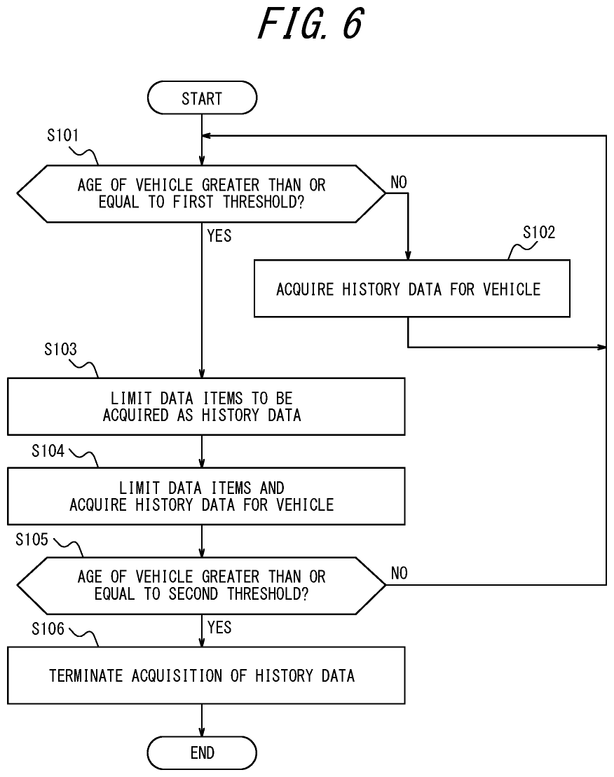

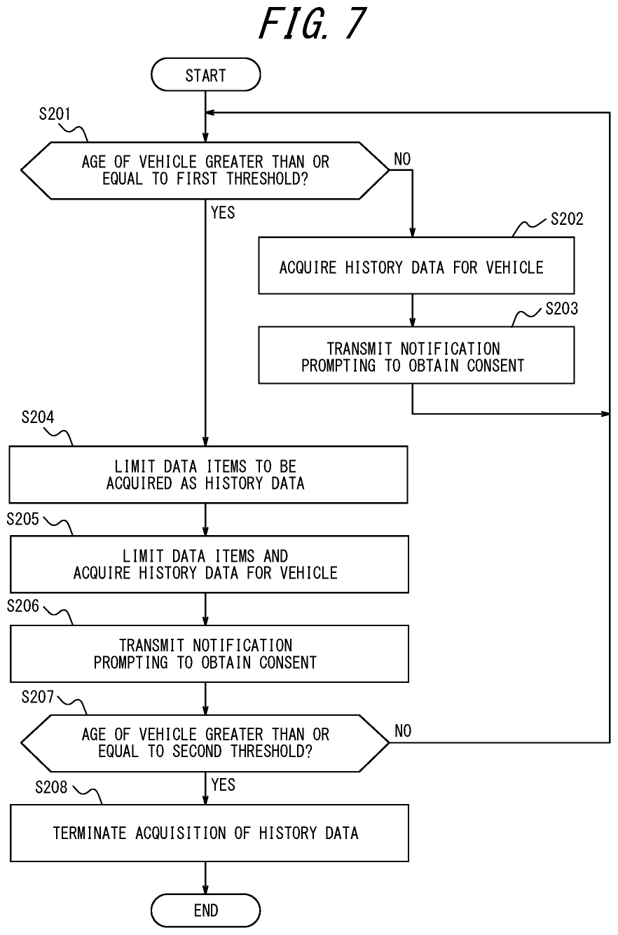

With reference to FIG. 6 and FIG. 7, operations of the server 20 in the system 1 according to the present embodiment will be described. FIG. 6 is a flowchart illustrating first operations of the server 20. FIG. 7 is a flowchart illustrating second operations of the server 20. These operations correspond to a method performed by the server 20 according to the present embodiment.

(First Operations of Server)

First, with reference to FIG. 6, first operations of the server 20 in the system 1 according to the present embodiment will be described.

In the first operations, the controller 23 of the server 20 repeatedly acquires the history data for the vehicle 10 by repeatedly performing these operations at a predetermined timing. The predetermined timing may be periodic or non-periodic. Specifically, the predetermined timing may be a predetermined time interval, such as every hour, or may be the timing when new history data is transmitted from the vehicle 10.

Step S101: The controller 23 of the server 20 determines whether the age of the vehicle 10 is greater than or equal to the first threshold.

Any method can be used to determine whether the age of the vehicle 10 is greater than or equal to the first threshold. For example, the controller 23 may determine whether the age of the vehicle 10 is greater than or equal to the first threshold based on information on the vehicle 10 stored in the memory 22 in advance. In the present embodiment, the first threshold is set to 10 years, for example. However, the first threshold is not limited to 10 years and may be set to any value.

In the example illustrated in FIG. 5, among the vehicles V1 to V4, the age is determined to be less than the first threshold (10 years in the present embodiment) and the process of step S102 is performed for vehicles V1 and V2. On the other hand, for vehicles V3 and V4, the vehicle age is determined to be greater than or equal to the first threshold, and the process of step S103 is performed.

Step S102: In the case in which the age of the vehicle 10 is determined to be less than the first threshold (step S101-No), the controller 23 of the server 20 acquires the history data for the vehicle 10.

Any method can be used to acquire the history data. For example, the controller 23 may receive the history data for the vehicle 10 directly from the vehicle 10 via the communication interface 21 and the network 40. Alternatively, the controller 23 may receive the history data for the vehicle 10 indirectly from the vehicle 10 by receiving the history data for the vehicle 10 from another server that receives the history data from the vehicle 10 via the communication interface 21 and the network 40. The controller 23 may add the acquired history data for the vehicle 10 to the history data for the vehicle 10 already stored in the memory 22 for storage as time-series data. Alternatively, the controller 23 may overwrite the history data for the vehicle 10 already stored in the memory 22 with the acquired history data for the vehicle 10 for storage as time-series data.

After completion of the process in step S102, the controller 23 of the server 20 repeats the process from step S101 at a predetermined timing.

In this way, in the example illustrated in FIG. 5, the history data for the vehicles V1 and V2, which are vehicles 10 with an age less than the first threshold, is repeatedly acquired and stored in the server 20.

Step S103: In the case in which the age of the vehicle 10 is determined to be greater than or equal to the first threshold (step S101—Yes), the controller 23 of the server 20 limits the data items to be acquired as history data.

Any method can be used to limit the data items to be acquired as history data. For example, the memory 22 of the server 20 may store, in advance, first data items to be acquired as history data for the vehicle 10 in the case in which the age of the vehicle 10 is less than the first threshold and second data items to be acquired as history data for the vehicle 10 in the case in which the age of the vehicle 10 is greater than or equal to the first threshold. Here, the second data items are a subset of the first data items. In the case in which the age of the vehicle 10 is determined to be greater than or equal to the first threshold, the controller 23 may limit the items to be acquired as history data from the first data items to the second data items, which are a subset of the first data items.

For example, the controller 23 of the server 20 may limit the data to be acquired as the history data to data related to distance traveled in the case in which the age of the vehicle 10 is equal to or greater than the first threshold. The data related to distance traveled, such as the total distance traveled, is considered an important factor in evaluating the value of the vehicle 10. In this way, when the age of the vehicle 10 increases, the acquisition of data related to the distance traveled, which has a large impact on evaluating the value of the vehicle 10, can be continued while the acquisition of other data items, which have a small impact on evaluating the value of the vehicle 10, is stopped, thereby controlling an increase in the amount of history data for the vehicle 10 stored in the server 20 or the like.

Step S104: The controller 23 of the server 20 limits the data items and acquires the history data for the vehicle 10.

Any method can be employed to acquire history data with limited data items. For example, the controller 23 may acquire the history data for the vehicle 10 using the method described above in step S102, after limiting the data items to be acquired as history data to the second data items. The controller 23 may store the acquired history data for the vehicle 10 in the memory 22.

In the example illustrated in FIG. 5, the history data for the vehicles V3 and V4, which are vehicles 10 with an age greater than or equal to the first threshold, is thus repeatedly acquired with limited data items and stored in the server 20.

Step S105: The controller 23 of the server 20 determines whether the age of the vehicle 10 is greater than or equal to a second threshold. In the present embodiment, the second threshold is set to 15 years, for example. The second threshold is not limited to 15 years, however, and may be set arbitrarily in a range greater than the first threshold. In the case in which the age of the vehicle 10 is determined to be less than the second threshold (step S105-No), the controller 23 of the server 20 repeats the process from step S101 at a predetermined timing.

Step S106: In the case in which the age of the vehicle 10 is determined to be greater than or equal to the second threshold (step S105—Yes), the controller 23 of the server 20 terminates acquisition of the history data and terminates the process. After terminating the process, the controller 23 may repeat the process at a predetermined timing.

With regard to the vehicle V3 out of the vehicles V3 and V4 in the example illustrated in FIG. 5, the age of the vehicle V3 is determined to be less than the second threshold (15 years in the present example), and the process from step S101 is repeated at a predetermined timing. With regard to the vehicle V4, however, the age of the vehicle V4 is determined to be greater than or equal to the second threshold, and no history data is acquired. In this way, in a case in which the history data for the vehicle 10 no longer needs to be acquired, such as when the age of the vehicle 10 has increased and the existence of the history data for the vehicle 10 no longer has an impact on evaluating the value of the vehicle, the acquisition of the history data for the vehicle 10 can be terminated, thereby further controlling an increase in the amount of history data for the vehicle 10 stored in the server 20 and the like.

(Second Operations of Server)

Next, with reference to FIG. 7, second operations of the server 20 in the system 1 according to the present embodiment will be described.

In the second operations, the controller 23 of the server 20 repeats these operations at a predetermined timing to repeatedly acquire the history data for the vehicle 10 and transmit a signal prompting to obtain consent to disclose the acquired history data to a third party. The history data is, for example, used to evaluate the value of the vehicle 10 when the vehicle 10 is sold as a used vehicle (for example, to calculate the appraisal value). Therefore, consent to disclose the history data to a third party, such as a used car dealer or a prospective buyer of a used car, may be obtained in conjunction with the acquisition of the history data. Hereinafter, “consent to disclose history data to a third party” is also referred to simply as “consent”.

In the present embodiment, consent to disclose history data to a third party is obtained for each user of the vehicle 10. Therefore, when a vehicle 10 is transferred, even if the consent of the previous user of the vehicle 10 has been obtained, the consent of the current user of the vehicle 10 needs to be obtained separately. Once consent is obtained from the user to disclose the history data for the vehicle 10 to a third party, consent is considered to have been obtained for all history data acquired while the user owns the vehicle 10. However, the handling of consent to disclose history data to a third party is not limited to the example illustrated in the present embodiment. The second operations are described below, focusing on the points that differ from the first operations.

Step S201: As in step S101, the controller 23 of the server 20 determines whether the age of the vehicle 10 is greater than or equal to the first threshold.

Step S202: As in step S102, in the case in which the age of the vehicle 10 is determined to be less than the first threshold (step S201-No), the controller 23 of the server 20 acquires the history data for the vehicle 10.

Step S203: In a case in which consent to disclose the history data for the vehicle 10 to a third party has not yet been obtained from the current user of the vehicle 10, the controller 23 of the server 20 transmits a signal prompting to obtain consent from the current user.

Any method can be used to determine whether consent has not yet been obtained from the current user. For example, the controller 23 may determine whether consent has not yet been obtained from the current user of the vehicle 10 based on information on the vehicle 10 stored in the memory 22.

In a case in which it is determined that consent to disclose the history data for the vehicle 10 to a third party has not yet been obtained from the current user of the vehicle 10, the controller 23 of the server 20 transmits a signal prompting to obtain consent from the current user of the vehicle 10. Specifically, the controller 23 transmits, via the communication interface 21 and the network 40, a signal to the terminal apparatus 30, installed at a dealership of the vehicle 10 or another such location, prompting to obtain consent from the current user of the vehicle 10. For example, the signal prompting to obtain consent from the current user of the vehicle 10 may include an instruction for the output interface 32 of the terminal apparatus 30 to output the message “Consent to disclose the history data to a third party has not been obtained from the current user of the vehicle 10. Please obtain consent from the current user of the vehicle 10”. In this case, the controller 35 of the terminal apparatus 30 that receives the signal can output the message, via the output interface 32, prompting to obtain consent from the current user of the vehicle 10. This enables the salesperson at the dealership of the vehicle 10 to see the message outputted via the output interface 32 of the terminal apparatus 30, contact the current user of the vehicle 10, and obtain consent to disclose the history data to a third party.

In the example illustrated in FIG. 5, it is determined whether consent from the current user has not yet been obtained for the vehicles V1 and V2, whose age is less than the first threshold, among the vehicles V1 to V4. For the vehicle V1, it is determined that consent has already been obtained from the current user, and no signal prompting to obtain consent is transmitted. On the other hand, for the vehicle V2, it is determined that consent from the current user has not yet been obtained, and a signal prompting to obtain consent is transmitted.

Step S204: As in step S103, in the case in which the age of the vehicle 10 is determined to be greater than or equal to the first threshold (step S201—Yes), the controller 23 of the server 20 limits the data items to be acquired as history data.

Step S205: As in step S104, the controller 23 of the server 20 limits the data items and obtains the history data for the vehicle 10.

Step S206: As in step S203, in a case in which consent to disclose the history data for the vehicle 10 to a third party has not yet been obtained from the current user of the vehicle 10, the controller 23 of the server 20 transmits a signal prompting to obtain consent from the current user.

In step S206, unlike in step S203, the controller 23 of the server 20 may refrain from transmitting a signal prompting to obtain consent, even if consent has not yet been obtained from the current user, in a case in which the age of the vehicle 10 is greater than or equal to a third threshold. In the present embodiment, the third threshold is the same as the second threshold, which is the age of the vehicle 10 at which the acquisition of history data is terminated. However, the third threshold may be set freely in a range greater than or equal to the second threshold.

In the example illustrated in FIG. 5, it is determined whether consent from the current user has not yet been obtained, and whether the vehicle age is less than the third threshold (15 years, which is the same as the second threshold in the present embodiment), for the vehicles V3 and V4, whose age is equal to or greater than the first threshold, among the vehicles V1 to V4. For the vehicle V3, it is determined that consent from the current user has not yet been obtained, and that the vehicle age is less than the third threshold. A signal prompting to obtain consent is therefore transmitted. On the other hand, for the vehicle V4, it is determined that consent from the current user has not yet been obtained, but that the vehicle age is greater than or equal to the third threshold. A signal prompting to obtain consent is therefore not transmitted. This can prevent the seeking of consent, from the user of the vehicle 10, to disclose the history data to a third party in situations in which the history data for the vehicle 10 will not be disclosed to a third party, such as after the acquisition of the history data for the vehicle 10 has been terminated. This can prevent the user of the vehicle 10 from being bothered by repeatedly being asking for consent, which would lower customer satisfaction.

Furthermore, the controller 23 of the server 20 may determine whether consent has already been obtained from the previous user of the vehicle 10. For example, the controller 23 may determine the existence of a previous user and the existence of consent from the previous based on information on the vehicle 10 stored in the memory 22. In a case in which consent has been obtained from the previous user, but not from the current user, the controller 23 may transmit a signal prompting to obtain consent from the current user.

On the other hand, the controller 23 of the server 20 may refrain from transmitting a signal prompting to obtain consent, even if consent has not yet been obtained from the current user, in a case in which consent has not been obtained from the previous user and the age of the vehicle 10 is less than the third threshold. In a case in which the vehicle 10 was transferred to the current user without consent to disclose the history data to a third party having been obtained from the previous user, it may be the case that the history data cannot be disclosed to a third party even if the current user provides consent, because consent to disclose the history data for the period when the previous user was using the vehicle 10 was not obtained. In such a case, it is possible to prevent a request for consent to disclose the history data to a third party from being made to the current user of the vehicle 10. This can prevent the user of the vehicle 10 from being bothered by repeatedly being asking for consent, which would lower customer satisfaction.

With regard to the vehicle V3, whose vehicle age is greater than or equal to the first threshold, in the example illustrated in FIG. 5, a signal prompting to obtain consent is transmitted in a case in which a determination is made based on whether consent from the current user has not yet been obtained, or whether the vehicle age is less than the third threshold. However, if a determination is also made regarding the vehicle V3 as to whether consent has been obtained from the previous user, the signal prompting to obtain consent is not transmitted, since consent has not been obtained from the previous user of the vehicle V3. This can prevent a request for consent to disclose the history data to a third party from being made to the current user of the vehicle V3.

Step S207: As in step S105, the controller 23 of the server 20 determines whether the age of the vehicle 10 is greater than or equal to the second threshold. In the case in which the age of the vehicle 10 is determined to be less than the second threshold (step S207-No), the controller 23 of the server 20 repeats the process from step S201 at a predetermined timing.

Step S208: As in step S106, in the case in which the age of the vehicle 10 is determined to be greater than or equal to the second threshold (step S207—Yes), the controller 23 of the server 20 terminates acquisition of the history data and terminates the process. After terminating the process, the controller 23 may repeat the process at a predetermined timing.

As described above, the server 20 according to the present embodiment repeatedly acquires history data for the vehicle 10. The server 20 then limits the data items to be acquired as history data in a case in which the age of the vehicle 10 is greater than or equal to the first threshold.

According to such a configuration, the data items of the history data that are repeatedly acquired from the vehicle 10 are limited in the case in which the age of the vehicle 10 is greater than or equal to the first threshold. Data items that have become less valuable to store as history data can thus be removed from among the targets for acquisition according to the age of the vehicle 10. Therefore, the technology for storing the history data for the vehicle 10 is improved in that an increase in the amount of the history data for the vehicle 10 stored in the server 20 or the like can be controlled in accordance with the age of the vehicle 10.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the terminal apparatus 30 is described as being installed at a dealership of the vehicle 10 or other such location. However, the terminal apparatus 30 may be a computer such as a smartphone used by the current user of the vehicle 10, or a computer such as a car navigation system installed in the vehicle 10. In such a case, the current user of the vehicle 10 can directly view the signal, transmitted from the server 20 to the terminal apparatus 30, prompting to obtain consent from the current user of the vehicle 10. This configuration facilitates obtaining consent from the current user of the vehicle 10.

In the above embodiments, the first, second, and third thresholds have been described as being determined in advance. However, the first, second, and third thresholds may be set by a statistical method such as machine learning or deep learning. For example, the first, second, and third thresholds may be set by a statistical method based on the history data for one or more vehicles 10 stored in the server 20 and the results of evaluating the value of those vehicles 10.

Similarly, in the above embodiments, the second data items, which are a subset of the first data items, were described as being determined in advance. However, the second data items may be selected from among the first data items by a statistical method such as machine learning or deep learning. For example, the second data items may be selected from among the first data items by a statistical method based on the history data for one or more vehicles 10 stored in the server 20 and the results of evaluating the value of the vehicles 10.

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A server comprising a controller configured to:
repeatedly acquire history data for a vehicle; and
limit data items acquired as the history data in a case in which an age of the vehicle is greater than or equal to a first threshold.

2. The server of claim 1, wherein the history data includes data measured using a sensor installed in the vehicle.

3. The server of claim 1, wherein the controller limits data to be acquired as the history data to data related to distance traveled in a case in which the age of the vehicle is greater than or equal to the first threshold.

4. The server of claim 1, wherein the controller terminates acquisition of the history data in a case in which the age of the vehicle is greater than or equal to a second threshold.

5. The server of claim 1, wherein
the history data is data to be disclosed to a third party, and
the controller
transmits a signal prompting to obtain consent, from a current user of the vehicle, to disclose the history data to a third party in a case in which the consent has not yet been obtained from the current user, and
refrains from transmitting a signal prompting to obtain the consent, even if the consent has not yet been obtained from the current user, in a case in which the age of the vehicle is greater than or equal to a third threshold.

6. The server of claim 5, wherein the third threshold is identical to a second threshold, which is the age of the vehicle at which acquisition of the history data is terminated.

7. The server of claim 5, wherein the controller
transmits a signal prompting to obtain the consent, from the current user, in a case in which the consent has been obtained from a previous user of the vehicle and the consent has not yet been obtained from the current user, and
refrains from transmitting a signal prompting to obtain the consent, even if the consent has not yet been obtained from the current user, in a case in which the consent has been obtained from the previous user and the age of the vehicle is greater than or equal to the third threshold.

8. A method to be performed by a server, the method comprising:
repeatedly acquiring history data for a vehicle; and
limiting data items acquired as the history data in a case in which an age of the vehicle is greater than or equal to a first threshold.

9. The method of claim 8, wherein the history data includes data measured using a sensor installed in the vehicle.

10. The method of claim 8, wherein the limiting of data items includes limiting data to be acquired as the history data to data related to distance traveled in a case in which the age of the vehicle is greater than or equal to the first threshold.

11. The method of claim 8, further comprising terminating acquisition of the history data in a case in which the age of the vehicle is greater than or equal to a second threshold.

12. The method of claim 8, wherein
the history data is data to be disclosed to a third party, and
the method further comprises
transmitting a signal prompting to obtain consent, from a current user of the vehicle, to disclose the history data to a third party in a case in which the consent has not yet been obtained from the current user; and
refraining from transmitting a signal prompting to obtain the consent, even if the consent has not yet been obtained from the current user, in a case in which the age of the vehicle is greater than or equal to a third threshold.

13. The method of claim 12, wherein the third threshold is identical to a second threshold, which is the age of the vehicle at which acquisition of the history data is terminated.

14. The method of claim 12, further comprising
transmitting a signal prompting to obtain the consent, from the current user, in a case in which the consent has been obtained from a previous user of the vehicle and the consent has not yet been obtained from the current user, and
refraining from transmitting a signal prompting to obtain the consent, even if the consent has not yet been obtained from the current user, in a case in which the consent has been obtained from the previous user and the age of the vehicle is greater than or equal to the third threshold.

15. A non-transitory computer readable medium storing a program configured to cause a computer to perform operations comprising:
repeatedly acquiring history data for a vehicle; and
limiting data items acquired as the history data in a case in which an age of the vehicle is greater than or equal to a first threshold.

16. The non-transitory computer readable medium of claim 15, wherein the history data includes data measured using a sensor installed in the vehicle.

17. The non-transitory computer readable medium of claim 15, wherein the operations further comprise limiting data to be acquired as the history data to data related to distance traveled in a case in which the age of the vehicle is greater than or equal to the first threshold.

18. The non-transitory computer readable medium of claim 15, wherein the operations further comprise terminating acquisition of the history data in a case in which the age of the vehicle is greater than or equal to a second threshold.

19. The non-transitory computer readable medium of claim 15, wherein
the history data is data to be disclosed to a third party, and
the operations further comprise
transmitting a signal prompting to obtain consent, from a current user of the vehicle, to disclose the history data to a third party in a case in which the consent has not yet been obtained from the current user; and
refraining from transmitting a signal prompting to obtain the consent, even if the consent has not yet been obtained from the current user, in a case in which the age of the vehicle is greater than or equal to a third threshold.

20. The non-transitory computer readable medium of claim 19, wherein the third threshold is identical to a second threshold, which is the age of the vehicle at which acquisition of the history data is terminated.
